(19) United States
(12) Patent Application Publication
(10) Pub. No.: US 2008/0147660 A1
(43) Pub. Date: Jun. 19, 2008

(54) Method for Arranging Object Data in Electronic Maps

(76) Inventor: Alexander Jarczyk, Freising (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/887,663

(22) PCT Filed: Mar. 15, 2006
(86) PCT No.: PCT/EP06/60770

§ 371 Date: Nov. 16, 2007

(30) Foreign Application Priority Data
Mar. 31, 2005 (DE) 10 2005 014 761.5

(51) Int. Cl. G06F 17/30; G06F 12/00

(52) U.S. Cl. 707/7; 707/200; 707/E17.046; 707/E17.012

(57) ABSTRACT

The invention relates to a method for arranging object data in electronic maps. The inventive method is characterized in that a data area (D) having the coordinate data of a spatial area is provided, object data regarding objects (Pi) are associated with the coordinate data, and clustering is carried out in order to reduce the data volume. For the purpose of clustering, various, spatially independent objects (Pi) are combined to give a cluster object (C1, C2, . . . ).

The invention relates to a method for arranging object data in electronic maps having the features of the precharacterizing part of patent claim 1.

Methods for arranging object data in electronic maps are commonly known. Generally, electronic maps involve the provision of a data area having coordinate data for a physical area. Object data for various objects are associated with the coordinate data. By way of example, the object data are a photograph or a text description for a particular locality or attraction at a particular location. To reduce the volume of data which need to be displayed on a map that is to be shown, clustering is performed. This involves the information data or object data for an object not being shown on the map itself but rather being represented by a small symbol which is depicted on the map at the relevant position for the associated coordinate data. By activating the symbol, for example by clicking on it with a cursor arrow in the case of presentation on a computer, a separate window which is opened over a map detail then displays the information in the form of the object data for this object. Particularly when scrolling with just a small displayed map detail through a larger displayable map area, reducing the object data to clustered symbols allows almost seamless scrolling on account of the reduced volume of data.

Generally, solutions for location-based services (LbS) permit spatial arrangement of multimedia data on electronic maps. With an increasingly large number of objects as the elements to be displayed, there is the problem that the performance of the displaying device no longer allows seamless scrolling of the information or object data on the electronic map. This becomes a particular problem when there is an extremely large number of objects in a particularly small physical area in comparison with neighboring areas having a very low density of objects.

The object of the invention is to propose a method for arranging object data in electronic maps which allows improved performance when displaying an electronic map on a device particularly when an enlarged detail from a larger data area is to be moved by scrolling within the larger data area. In addition, the clustering is intended to be able to be performed with little complexity.

This object is achieved by the method for arranging object data in electronic maps having the features of patent claim 1. Advantageous refinements are the subject matter of dependent claims.

Accordingly, preference is given to a method for arranging object data in electronic maps in which a data area having coordinate data for a physical area is provided, object data for objects are associated with the coordinate data, and clustering to reduce the volume of data is performed, the clustering involving various, physically separate objects being combined to form a cluster object.

Particular preference is given to a method in which the clustering is performed such that two respective neighboring objects in a cluster are situated within a prescribed distance value for the neighboring objects.

Particular preference is given to a method in which various distance values are prescribed for various physical area sections for the clustering.

Particular preference is given to a method in which a plurality of databases or copies of a data area having various clusters are provided on the basis of a respective different distance value, and a map to be shown having various area sections is compiled from respective relevant sections of the accordingly clustered databases.

Particular preference is given to a method in which the objects are sorted among one another according to their distance values before the clustering. Particular preference is given to a method in which the objects are sorted according to the criterion of the minimum distances from one another over the total number of all distances.

Particular preference is given to a method in which the objects are arranged in a form structured along a path. Particular preference is given to a method in which the objects are arranged in a form structured in paths of a tree structure. Particular preference is given to a method in which the clustering is performed along the paths for neighboring objects.

Particular preference is given to a method in which, in the manner of zooming, the distance values, particularly maximum distance values for respective neighboring objects, are changed in order to form clusters. Particular preference is given to a method in which the clustering is performed along the paths.

Particular preference is given to a method in which distance-dependent sorting of the objects or of object relationships among one another and/or distance-dependent formation of clusters is performed when a new object is added along one or more of the existing paths.

Particular preference is given to a method in which the addition of a new object involves existing paths being checked and possibly deleted and/or new paths being added.

Accordingly, particular preference is given to a method for arranging object data in electronic maps in which a data area having coordinate data for a physical area is provided, object data for objects are associated with the coordinate data, and clustering to reduce the volume of data is performed, the clustering involving various, physically separate objects being combined to form at least one cluster object.

By way of example, the object data may be a photograph of a building which forms the object. A recorded audio sequence to be played over a loudspeaker or an informative text may also be provided as object data for an object, for example, and associated with the relevant coordinate data for the object within the data area.

Normally, the data area of an electronic map is an area which is physically very much larger than the area which will be displayed on a screen of a display device as the map to be shown or the map detail to be shown.

In line with one main aspect, not only are object data clustered to form an individual object through reduction to a symbol depicted in the map presentation, but rather various objects or the object data for various objects are clustered to form a cluster object. Instead of showing, by way of example, three symbols on a map for a town hall, a church and a restaurant with respective informative texts or photographs as object data for three objects individually, a large map presentation scale allows just a single symbol to be displayed as a cluster object, which is first resolved on another presentation scale at a higher resolution as three individual objects or symbols for relevant objects. When scrolling over an inner-urban area with a multiplicity of individual objects on a map section to be shown, accordingly only a significantly reduced number of cluster objects is displayed, so that seamless scrolling of the information on the electronic map is made possible. In particular, it is also possible to provide various areas on the map having different cluster densities without restricting performance when seamlessly scrolling from one clustering density to another.

Realtime clusterings are therefore possible for clusterings with one or more cluster intensities on both undistorted and distorted maps. Zoom-dependent clusterings easily become possible. Automatic clusterings geared to the number of units or objects available as a maximum are advantageously implementable. In this context, a threshold can always be kept such that the number of clusters and objects does not exceed a particular desired number.

An exemplary embodiment is explained in more detail below with reference to the drawing, in which:

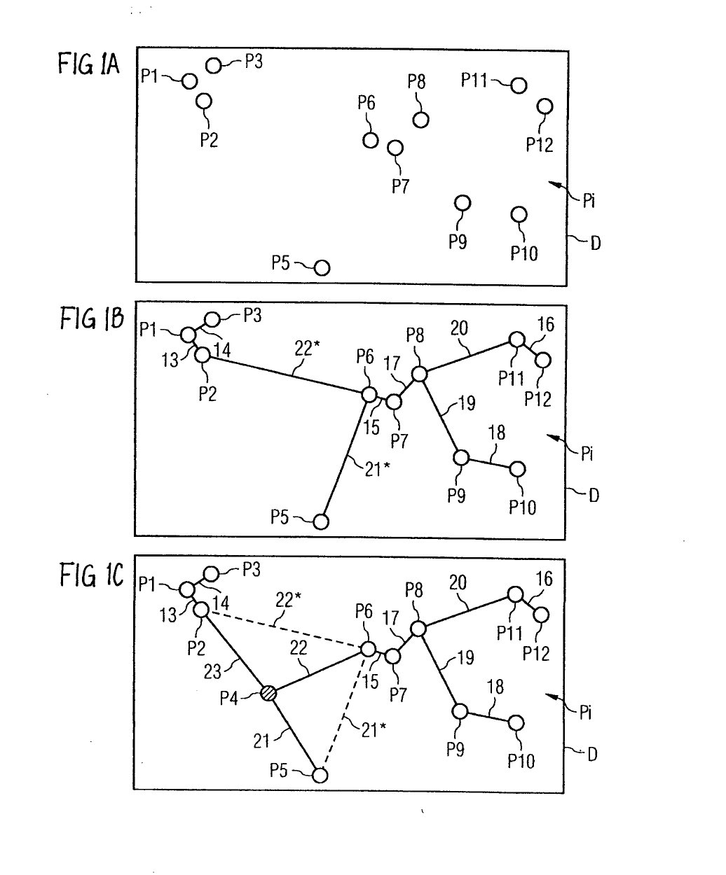

FIG. 1 shows a data area for a physical area in which object data for objects are associated with relevant coordinate data for the data area, and also distance information between individual instances of the objects;

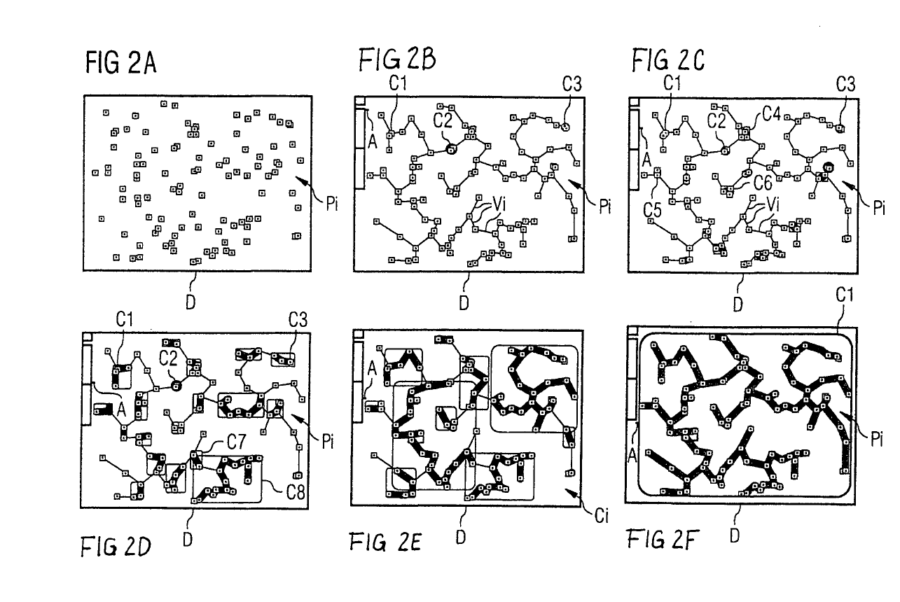

FIG. 2 uses various depictions based on a multiplicity of individual objects in a data area to show an increasingly high level of clustering for the objects;

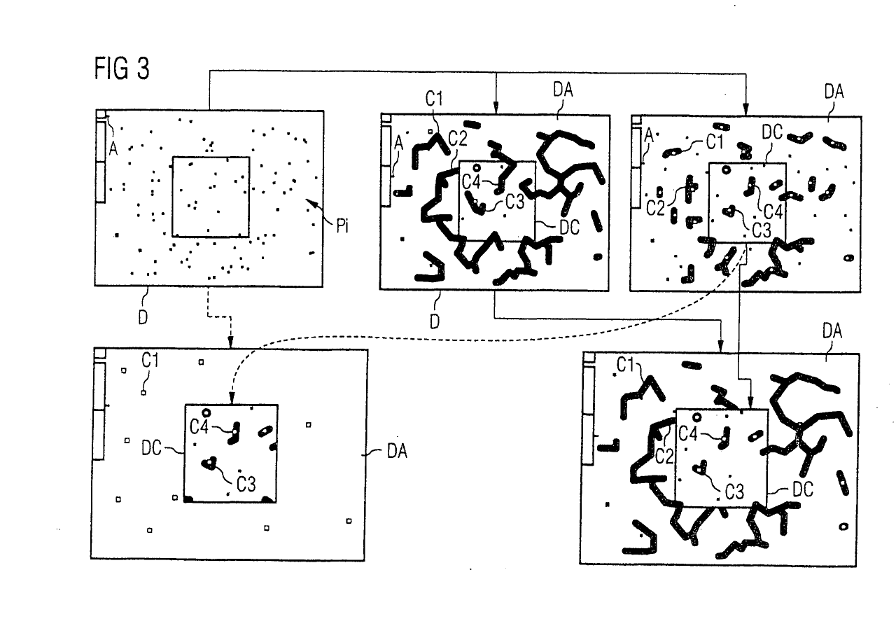

FIG. 3 takes a multiplicity of individual objects in a data area as a basis for showing different levels of clustering for a central area of a map and an outer area of a map to be shown and also combined illustrations with a central inner area and a peripheral outer area of the map with different levels of clustering;

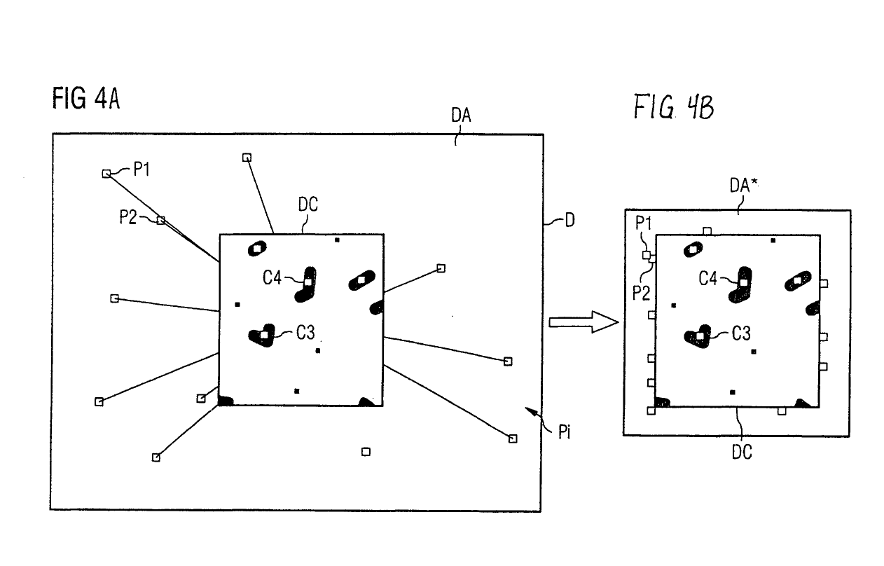

FIG. 4 shows an illustration with a distorted outer area, in comparison with an embodiment as shown in FIG. 3; and

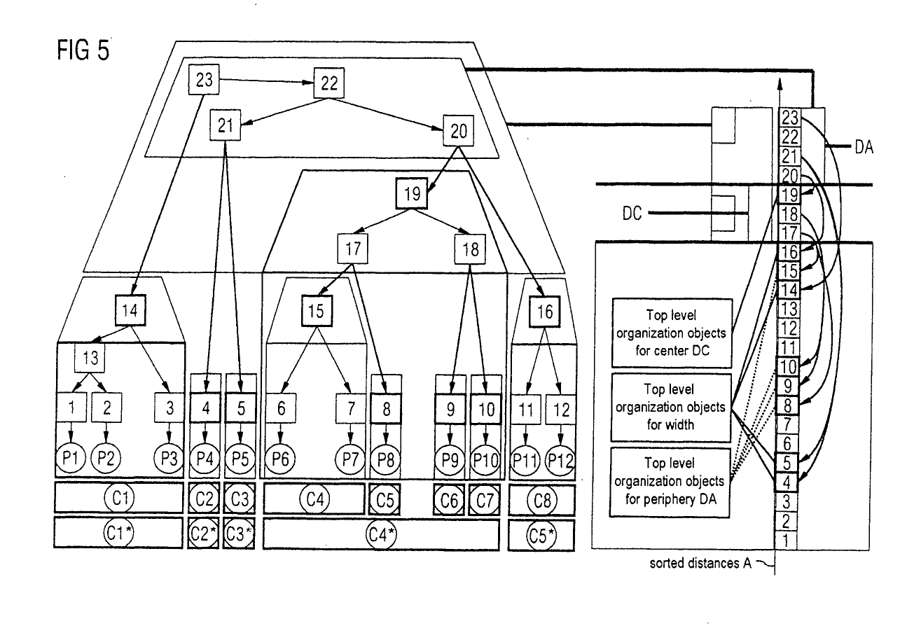

FIG. 5 shows a tree structure to illustrate data structuring to allow particularly rapid adjustment of a clustering intensity.

As can be seen from the top of FIG. 1, a data area D having coordinate data for a physical area contains a multiplicity of objects Pi, P1-P3, P5-P12. As usual, the objects P1-P12 are arranged by virtue of relevant object data being associated with the coordinate data for the underlying data area D.

The center of FIG. 1 depicts the same data area D with the same objects P1-P3, P5-P12. To prepare for clustering, a first object P1 is taken as a basis for determining respective shortest distances or distance values 13, 14 for all the other objects P2, P3, P5-P12 in the data area D. Subsequently, the respective shortest distances to all the objects P1, P3, P5-P12 in the data area D are likewise determined from the closest neighboring object P2. Ultimately, a path connecting all the objects P1-P3, P5-P12 to one another is determined, preferably recursively, while respectively taking account of the shortest effective connection options. The center depiction in FIG. 1 shows the resultant minimum distances or distance values 13-20, 21*, 22* by means of appropriate connecting lines.

The minimum distance values 13-20, 21*, 22* are understood, in particular, to mean values which take account of a weighting in order to perform optimization over the total number of all possible distances between two respective instances from the multiplicity of objects Pi by reducing the total path length, for example. To prepare for particularly effective clustering, the determined distance values 13-20, 21*, 22* with their object pairs are entered in a list in a form sorted according to the numerical value of the distances.

The data area D shown at the bottom of FIG. 1 subsequently has a further, fourth object P4 added to the multiplicity of objects P1-P3, P5-P12. Taking the freshly added object P4 as a basis, the respective shortest distances to all the other objects P1-P3, P5-P12 are again determined. In the example illustrated, it transpires that the originally shortest distance value 22* or path between the second and sixth objects P2, P6 is no longer optimum when taking account of the total number of shortest possible connections. Accordingly, the original connected pair of these two objects P2, P6 and the path or shortest distance value 22* between them is deleted from the previously created list of shortest distances. Instead, a new shortest distance value 22 or a corresponding path between the freshly inserted object P4 and the original sixth object P6 is stipulated. In addition, further paths or shortest distances 23, 21 from the freshly inserted object P4 to the original second object P2 or the original fifth object P5 are used. Accordingly, the previous distance pair comprising the original fifth and sixth objects P5, P6 and their shortest distance value 21* are also deleted from the list.

FIG. 2 shows six data areas D which each have the same multiplicity of objects Pi. The first illustrated data area D at the top left shows the objects Pi, which are not connected to one another, at the relevant positions in a map. In the center illustration in the top row, the application of an appropriate algorithm to determine the shortest distances is additionally followed by the depiction of appropriate connections Vi showing the respective suitable shortest distances between two objects, as are also entered in the list. Again, the path running through the multiplicity of objects Pi has individual branch points if a linear route is found to be unsuitable in terms of the optimum minimum distances in the total number of all distances, so that a limited tree structure is produced.

On the left-hand side of the area shown, a scale is displayed which indicates the clustering intensity selected for this illustration. The clustering for individual instances of the objects Pi is chosen on the basis of the respective distance values Pi for two respective neighboring instances of the objects Pi. The center depiction in the top row shows a very low clustering density or clustering intensity where only objects Pi arranged very close to one another are clustered. Accordingly, only three clusters C1, C2, C3 are formed. In this case, the clusters are formed through orientation to the connections Vi or paths formed, which have previously been formed on the basis of the criterion of shortest possible distances, in order to allow particularly rapid adjustment of the clustering density. Each of the clusters then forms a separate cluster object with the combined objects, the clusters C1-C3 respectively being displayed as a single cluster object on a map which will actually be shown, particularly being displayed as a symbol.

Starting from the center depiction in the top row to the right-hand depiction and onward from left to right in the bottom depiction, the number of clusters C1-C8 formed from a respective plurality of individual objects Pi first increases and then decreases again down to, ultimately, a single cluster C1 comprising all the objects Pi. If each of the individual objects Pi in the illustration at the top left were to be considered as a separate cluster with a lowest possible clustering intensity, the number of clusters would continually decrease with increasing clustering density or clustering intensity.

The top left of FIG. 3 again shows a data area D which will be shown in full on a display device as a map and possibly forms a subsidiary detail from a larger data area. The data area again contains a multiplicity of objects Pi. The center and right-hand side of the top row show two different illustrations of this data area D with different clustering intensity, the clustering intensity again being dependent on the respective lowest distance values A between two respective neighboring objects Pi.

The bottom left-hand side shows a further illustration of the data area D in which a medium clustering intensity is chosen for a central area DC as a first area section in line with the top left-hand illustration. By contrast, the outer area or the periphery DA of the data area D has very little or even no clustering. A representation of this kind allows a map with low cluster object resolution to be shown in the central map area, resulting in reduced demands on the concentration of a viewer of the map to be shown who is scrolling over a larger data area.

By contrast, the bottom right-hand illustration shows a central area DC with, again, a medium level of cluster formation and two clusters C3, C4, while the periphery DA has a much higher level of clustering in line with the center illustration in the top row. Accordingly, the periphery DA of the data area D contains only a few large clusters C1, C2. A representation of this kind allows particularly effective and seamless scrolling through a larger data area, with cluster objects being displayed to the viewer of the displayed and shown map with a larger presentation resolution, that is to say with a lower clustering intensity, in each case for the central area DC. The outer area formed by the periphery DA is usually of less interest to the viewer during a scrolling action and is afforded less attention, so that a high level of clustering intensity is feasible for the periphery.

On the basis of the depiction at the bottom left of FIG. 3, FIG. 4 shows a situation with a central area DC having a medium level of clustering intensity and individual cluster objects C3, C4, while individual objects P1, P2 are shown in unclustered form in the outer area. To allow a substantially enlarged map area to be viewed, a physically distorted presentation is used in which the central area DC is depicted true to scale while the presentation scale at the outer edges of the presentation area is distorted or increased to an ever greater extent. Objects P1, P2 which are actually a long way from the central area DC are therefore depicted close to the central area DC. However, particularly when such distorted depiction is applied, it is more advantageous to have a clustering intensity which is ever higher at the outer circumference of the periphery DA*, but this is not shown in the present case merely for reasons of presentation.

FIG. 5 shows a data structure for simultaneously displaying and adjusting various clustering intensities for the above embodiments and further embodiments in a physical memory depiction with two zones for a central area DC as the center and for a periphery DA of the area to be shown. In addition, two different cluster intensities are considered. The basis for the tree structure shown is formed by the arrangement of objects Pi, i=1, 2, . . . , 12 with the respective connections or shortest distance values 13-23 from FIG. 1. For reasons of presentation and to simplify an algorithm which is accordingly to be set up, each of the individual objects P1-P12 has an associated separate clustering or organization object 1, 2, . . . , or . . . 12 on a first clustering plane. This forms first organization objects 1-12 which ultimately have a respective associated minimum distance value with the effective value 0 for connection to themselves. The other organization objects 13-23 shown correspond, by contrast, to recursively formed shortest distances taking account of the total number of objects P1-P12 and the total number of distance values 1-23, so that the terms distance value and organization objects are interchangeable. As can be seen from FIG. 1 and also from the bar diagram on the right of FIG. 5, the individual instances of these organization objects 1-23 are in this case accordingly organized in a list, set up as stated in respect of FIG. 2, for example, on the basis of the criterion of shortest effective distances to form a path structure or a tree structure.

The bottom left of FIG. 5 shows two different clustering intensities with, accordingly, five formed clusters C1*-C5* and eight formed clusters C1-C8. In the case of less intensive clustering with eight clusters C1-C8, eight groupings are formed as clusters C2, C3, C5-C7, with five of the objects P4, P5, P8-P10 respectively forming a separate cluster object on their own with just themselves as a single object. In addition, two cluster objects are formed as the clusters C4, C8 with the objects P6, P7 and P11, P12. These two clusters C4, C8 are connected by the organization objects to the numerical values 15 and 16 as top cluster elements or top level organization objects. Another large cluster object is formed by the first cluster C1 with the objects P1-P3, this first cluster C1 having an associated first organization object 13 for connecting the first objects P1, P2 and an associated second organization object 14 for connecting the third object P3 to the first organization object 13 and, above it, to the first object P1. In FIG. 1, the first cluster C1 would accordingly be formed by the first three objects P1, P2, P3, which are connected to one another by the organization objects or shortest distance values 13, 14. The fourth cluster C4 in FIG. 1 would be formed by the centrally arranged points P6, P7 with the organization object 15 between them. The eighth cluster C8 would be formed by the points P11, P12 with the organization object or distance value 16.

If the clustering intensity needs to be increased, this is equated to an increase in the underlying distance values A, so that no longer are just the objects Pi clustered to form the organization objects, i.e. distance values 1-16, but rather, in line with the exemplary embodiment shown, clustering is performed as far as the organization object or distance value 19, for example. The effect of this is that instead of eight now only five clusters C1*-C5* are formed as per the depiction at the bottom left of FIG. 5. While the first three and the last of the previously formed clusters C1-C3, C8 remain clustered in effectively unaltered form, the remaining original clusters C4-C7 are combined to form a single new cluster C4*. In this case, the previous organization objects 8, 15 are connected to one another by the organization object 17, the original organization objects 9, 10 are connected to one another by the organization object 18, and the two organization objects 17, 18 are connected by the organization object 19 which is superordinate thereto.

This results in simple formation of a large cluster object for the individual objects P6-P10. In this context, this large cluster object C4* now no longer comprises only individual objects P6-P8 from a central area DC but also objects P9, P10 from the periphery DA of the data area D to be shown.

It is therefore possible to identify a tree structure which starts at an organization object or largest minimizable distance value 23 and forms a breakdown on the basis of respective next-smallest organization objects or shorter distances 22, 21, 20, . . . , 13 using path formations and branch points in a data structure. This provides a simple way of simultaneously displaying and adjusting various cluster intensities in a physical stored map presentation. Without respectively recalculating individual objects and their map coordinates and object relationships relative to one another in full in order to form new cluster objects, it is a simple manner to take the respectively desired maximum distance value or organization object as a basis for performing or adjusting clustering.

The concept allows seamless and powerful scrolling of automatically clustered physically arranged objects or information units. In this case, the clustering intensity can be set separately and in real time for each desired area. The memory requirement for the data structures needed for this is linear, and the time involvement for the calculation, which needs to be performed only once, is the square of the total number of objects. Every further addition of a new object is merely proportional to the objects Pi previously existing in the system. Hence, a method for appropriately arranging object data on electronic data, particularly for adjusting a clustering intensity, even for daily use of the clustering of, by way of example, new images as objects which have been recorded using a digital camera, is powerful enough to be used conveniently by the user in everyday dealings. In this context, it can be particularly highlighted that clustering from a maximum clustering intensity with just a single large cluster through to minimal clustering can be visualized in real time even for large volumes of data. In addition, it is advantageously possible to use more than one clustering intensity or clustering level in real time on the same data structure. If appropriate, various clustering intensities can be produced on various copies of the object data from the data area in order to be able to open respective map details from the various copies for a map which is to be shown with sections having different levels of clustering.

To implement an appropriate procedure, in a first step a suitable data structure is advantageously formed for realtime clustering in which the shortest distances between two respective objects from the multiplicity of objects Pi are determined and stored.

In the case of freshly added objects, in a first step the freshly added object is preferably connected to the object which provides the minimum distance to all previously existing objects. This procedure is effective apart from in the case of the first object, which is merely positioned without forming and storing a connected pair. In a second step for incorporating a new object, the distances between existing connected pairs or object pairs are checked. Should it become possible to measure the maximum distance between any existing object pair from a previously formed path or distance, which has been recursively determined from the original object with a minimum distance to all previous other objects for all elements connected to this object and the successors, with a shorter distance between the new object and a succeeding object on the same path to two further objects then the existing connection, as a maximum connection between the two further objects, is first of all deleted and is then replaced by a new connection, as also illustrated by means of the transition from the center to the bottom illustration in FIG. 1. This procedure is continued until an end of the path or a branch point has been reached, with ends prompting the end of path formation and branch points initiating respective new branches in a recursion tree of this kind. The procedure is continued, possibly also with freshly arising paths, until such recursive path reformation has processed or replaced all existing connecting distances with any new connecting distances between the new object and the existing objects.

When a new object is incorporated, a third step is finally used to return a list of distance pairs or distance values, organized on the basis of distances, which form the organization objects or list on the right of FIG. 5. If appropriate, such list formation can also actually be done in the first step of incorporating a new object.

In preparation for use of the data structure for realtime clustering, particularly also adjustment of a clustering intensity while showing a map or a map detail as a detail from the data area, all connected pairs or distance values A are stored in a list in a form sorted according to distances and are managed by means of an operator control element in the form of a mechanically operable, electronically operable or virtually controllable switch such that an organization object or distance can be stipulated in proportion to the position of the operator control element, as described with reference to FIG. 5 for the various clustering intensities from FIG. 2.

An advantageous algorithm or an appropriate procedure for clustering preferably starts at a maximum resolution or minimum clustering intensity for which all objects Pi form their own cluster with just themselves as an object. As the clustering intensity increases, the next organization object or the next distance value A in the list organized according to distances is respectively clustered for this length of time, with both objects in a relevant pair of objects from the relevant organization object or the relevant connection of two objects which is determined by the distance first of all determining their associated next highest cluster. As the intensity increases further, the total tree structure from FIG. 5 is ultimately processed, with an ever larger number of individual clusters of a plurality of objects usually being produced and ultimately the number of individual clusters decreasing to form ever fewer clusters with an all the greater number of individual objects per cluster. The formation of a list organized according to distances and of an accordingly formable tree structure allows clusters to be visualized in real time even for larger volumes of data, with clusterings being able to be formed from a maximum clustering intensity with ultimately just a single large cluster through to a minimum clustering intensity with ultimately each individual object as a separate cluster, which is then not actually a genuine cluster.

Advantageously, such a procedure on a plurality of clustering levels can be applied to one and the same data structure. To this end, one or more intermediate layers in the organized list with the organization objects can be created in the clustering tree shown in FIG. 5.

If such a procedure is clustered to different degrees for two different regions, for example with finer granulation for the central area DC and with coarser granulation for the periphery DA, then two-level clustering is produced which allows the user to work in the two regions with different clusterings in real time.

1.-13. (canceled)

14. A method for arranging object data in an electronic map, comprising the steps of:
selecting a data area of an electronic map having coordinate data corresponding to a physical area;
providing object data for objects associated with the coordinate data in the data area; and
clustering the objects to reduce the volume of data in the data area, wherein said step of clustering includes combining a plurality of separate ones of the objects to form a cluster object.

15. The method of claim 14, wherein said step of clustering is performed such that the coordinate data of each pair of respective neighboring objects in the cluster object are situated within a prescribed distance value for the neighboring objects.

16. The method of claim 15, wherein different distance values are prescribed for respective physical area sections of the data area for the step of clustering.

17. The method of claim 16, wherein said step of clustering further comprises generating a plurality of databases or copies of the data area, each of said databases or copies of the data area having cluster objects based on different distance values, and showing a map with different area sections compiled from different ones of the plurality of databases or copies of the data area.

18. The method of claim 17, further comprising the step of sorting the objects among one another according to the distance values between respective pairs of the objects before said step of clustering.

19. The method of claim 18, wherein said step of sorting comprises sorting the objects according to the criterion of the minimum distances from one another over the total number of all distances.

20. The method of claim 18, further comprising the step of arranging the objects in a form structured along a path formed by the minimum distances.

21. The method of claim 18, further comprising the steps of arranging the objects in a form structured in paths of a tree structure.

22. The method of claim 20, wherein said step of clustering is performed along the paths for neighboring objects.

23. The method of claim 21, wherein said step of clustering is performed along the paths for the neighboring objects.

24. The method of claim 15, further comprising the step of changing prescribed distance value for the neighboring objects and repeating said step of clustering based on the new prescribed distance value.

25. The method of claim 24, in which the clustering is performed along the paths between neighboring objects.

26. The method of claim 18, further comprising the step of adding a new object in the data area, and repeating said steps of sorting and clustering to include the new object.

27. The method of claim 20, further comprising the step of adding a new object in the data area, checking the existing paths and reconfiguring the paths to include the new object, wherein said step of reconfiguring including at least one of adding a new path and deleting one of the existing paths.

28. The method of claim 14, further comprising the step of sorting the objects among one another according to the distance values between respective pairs of the objects before said step of clustering.

29. The method of claim 28, wherein said step of sorting comprises sorting the objects according to the criterion of the minimum distances from one another over the total number of all distances.

30. The method of claim 28, further comprising the step of arranging the objects in a form structured along a path formed by the minimum distances.

31. The method of claim 28, further comprising the steps of arranging the objects in a form structured in paths of a tree structure.

32. The method of claim 30, wherein said step of clustering is performed along the paths for neighboring objects.

33. The method of claim 31, wherein said step of clustering is performed along the paths for the neighboring objects.

34. The method of claim 28, further comprising the step of changing prescribed distance value to a new prescribed distance value for the neighboring objects and repeating said steps of sorting and clustering based on the new prescribed distance value.
